(19) United States
(12) Patent Application Publication
(10) Pub. No.: US 2022/0288832 A1
(43) Pub. Date: Sep. 15, 2022

(54) MELT DISTRIBUTOR

(71) Applicant: Kautex Maschinenbau GmbH, Bonn (DE)

(72) Inventors: Maurice MIELKE, Much (DE); Michael MÜLLER, Nörvenich (DE); Werner HOLZKY, Troisdorf (DE)

(21) Appl. No.: 17/632,934

(22) PCT Filed: Jul. 31, 2020
(86) PCT No.: PCT/EP2020/071680

§ 371 Date: Feb. 4, 2022

(30) Foreign Application Priority Data
Aug. 6, 2019 (DE) 10 2019 121 172.7
Oct. 15, 2019 (DE) 10 2019 127 661.6

(51) Int. Cl. B29C 48/71; B29C 48/345; B29C 48/495; B29C 48/335; B29C 48/21

(52) U.S. Cl. CPC B29C 48/71; B29C 48/345; B29C 48/495; B29C 48/335; B29C 48/21

(57) ABSTRACT

A melt distributor (1) having a plurality of bifurcated melt passages melt passages (5.1, 5.2, 5.3) for redirecting and distributing melt flows from a thermoplastic plastic. The melt distributor can be connected to a multiple extrusion head for producing multi-layer preforms. The branched junction (8) is configured as a rounded y-shaped conduit branch, and at least the branched junction (8) between a supply passage part (6) and the discharging passage parts (7.1, 7.2) of the bifurcated melt passage follows a continuously bent curve, the curvature of which is not equal to zero. The rounded and continuously bent configuration of the branched junction (8) contributes to shorter flow paths and avoids the formation of dead zones.

### CROSS REFERENCE TO RELATED APPLICATIONS

This application is a United States National Phase Application of International Application, PCT/EP2020/071680, filed Jul. 31, 2020, and claims the benefit of priority under 35 U.S.C. § 119 of German Applications 10 2019 121 172.7, filed Aug. 6, 2019 and 10 2019 127 661.6, filed Oct. 15, 2019, the entire contents of which are incorporated herein by reference.

### TECHNICAL FIELD

The present invention pertains to a melt distributor, and especially to a melt distributor with a plurality of bifurcated (melt) line passages for deflecting and distributing melts from thermoplastic plastic, The melt distributor can be connected indirectly or directly to a multilayer extrusion head for the manufacture of multilayer preforms from the melt.

### TECHNICAL BACKGROUND

DE 2100192 A discloses that two tubular partial flows essentially extending coaxially to one another, the seam areas of which extending in the longitudinal direction are arranged offset to one another in the circumferential direction, are manufactured from thermoplastic plastic. These partial flows are then merged in the plastic state radially in an extrusion head for forming a tubular preform.

In addition, multilayer extrusion heads for the manufacture of preforms, which have a plurality of layers, for example, up to six layers, are known from the in-house state of the art.

In another in-house state of the art known at the priority date, the melt distributor has a plurality of bifurcated pipelines, of which each
has a feeding pipeline part for the melt as well as two discharging pipeline parts for the melt split into two lines,
has a junction between the feeding pipeline part and the two discharging pipeline parts, and
each feeding pipeline part has an inlet for the melt at the end and each discharging pipeline part has an outlet for the melt at the end, wherein all inlets are arranged on a first side of the melt distributor and all outlets are arranged on an opposite side of the melt distributor.

The melt distributor is located upstream of an extrusion head for the manufacture of preforms, especially of a multilayer extrusion head for the manufacture of multilayer, tubular preforms.

Finally, a melt distributor (30), which has a plurality of bifurcated pipelines (31.1, 31.2, 31.3) corresponding to the number of the layers of the multilayer preform to be manufactured with the multilayer extrusion head, wherein each bifurcated pipeline (31.1, 31.2, 31.3) splits the melt flow into two partial flows per layer, is known from the in-house state of the art shown in FIG. 1.

The melt distributor (30) shown in FIG. 1 has a total of three bifurcated pipelines (31.1, 31.2, 31.3), which split the three different melt flows each into two partial flows.

The in-house prior-art melt distributor (30) comprises an upper plate (32) and a lower plate (33) with a horizontal separating plane (34) between the two plates (32, 33). The feeding, linear pipeline parts (35) of the three bifurcated pipelines (31.1, 31.2, 31.3) are inserted as holes into the upper plate (32). The two discharging, linear pipeline parts (36.1, 36.2) of the three bifurcated pipelines (31.1, 31.2, 31.3) are each inserted as holes into the lower plate (33). The junction (37) between the feeding pipeline part (35) and the two discharging pipeline parts (36.1, 36.2) of each bifurcated pipeline (31.1, 31.2, 31.3) is produced by horizontal channels running in the separating plane (34). The melt flowing in from the linear pipeline part (35) is in each case distributed to the two channels (37) in a T-shaped inflow zone. The melt flow experiences an intermittent deflection by 90° from the flow direction in the feeding pipeline part (35) in each of the channels (37) and a new, intermittent or intermittently bent deflection by 90°, furthermore, during the entry from the channels (37) into the discharging pipeline parts (36.1, 36.2). The channels are each inserted halfway into the upper plate (32) and halfway into the lower plate (33) by milling.

The in-house melt distributor according to FIG. 1 known at the priority date has a complicated manufacture. Further, the melt flow in the area of the junction (37) is deflected in this case in the direction of the two discharging pipes (36.1, 36.2) by 90° (angular degree) into the channels extending in the separating plane (34). This deflection by 90° produces dead zones in the melt flow, in which there is a risk of a thermal degradation of the melt. Furthermore, a melt with a precursor color is purged from dead zones by the next melt with a different color only in a very delayed manner during a change in color, so that the change in color is prolonged. The articles manufactured during the color change are not usable because of the color mixing of the previous color and the new color. In addition, a junction configured in this manner extends the flow path of the melt in the distributor.

### SUMMARY

Based on this in-house state of the art, a basic object of the present invention is to provide an improved melt distributor, which has especially shorter flow paths, and/or which avoids the formation of dead zones, especially in the area of the junction, and/or which can be manufactured in a simpler manner. Furthermore, it is advantageous when the melt distributor makes possible an adaptation of the flow geometry to the flow of the melt.

The present disclosure comprises different aspects, which may individually or in combination make a contribution to accomplishing the object.

The melt distributor according to the present disclosure is preferably intended to be connected to a multilayer extrusion head for the manufacture of multilayer preforms. The preforms are then formed from the melt, which is fed to the multilayer extrusion head from the melt distributor.

The melt distributor according to the present disclosure is intended and configured to deflect and distribute one or preferably a plurality of melt flows from thermoplastic plastic. For this purpose, it has one or more bifurcated melt passages.

According to a first aspect, a melt distributor is provided, in which at least the branched junction between the feeding passage part and the two discharging passage parts of each bifurcated melt passage follows a bent curve, the curvature of which is not equal to zero.

Curvature is defined as the change in direction during the passage of the curve. The curvature of a straight line is equal to zero everywhere because its direction does not change. An arc of a circle has the same curvature everywhere because its direction changes equally everywhere. A short curve may have locally different curvature values.

The configuration of at least the branched junction of the melt distributor, which is continuously chamfered, i.e., is not linear and also does not comprise any 90° bend, contributes to shorter flow paths and avoids the formation of dead zones. In this connection, the avoidance of dead zones is especially facilitated by the continuity of the curvature, i.e., due to the avoidance of intermittent jumps of the curvature value in contiguous areas of the curve.

Due to the absence of any intermittent deflections between the passage parts, the junction does not need any horizontal channels in a separating plane, as was the case between the two plates of the melt distributor according to the in-house state of the art.

For formation of rounded junctions at the two discharging passage parts, small radii are further preferably avoided. The arc lengths of the bent curves at each discharging passage part in the branched junction preferably have a center angle of less than 90°.

The junction may further be configured as a rounded and preferably symmetrical Y-shaped passage branch. In this case, the Y shape is in contrast to the T-shaped junction, which is present in the in-house state of the art according to FIG. 1.

The feeding passage part may have a upstream section which is arranged upstream of the branched junction. The discharging passage parts may have a downstream section which is arranged downstream of the branched junction. For shortening the length of the flow paths as well as for adapting the geometry of the bifurcated melt passages to the flow, these sections of the feeding passage part and/or of the two discharging passage parts, which sections adjoin the junction, also preferably follow a bent curve, the curvature of which is continuous and further preferably not equal to zero. The bifurcated melt passage has a locally linear course in a preferred configuration, only at the inlet at the end and at the at least two outlets, in order to ensure a matching connection geometry for the inlet and the outlets. In the remaining sections, all passage parts overall follow a continuous bent curve.

In one embodiment of the present invention, all inlets of the plurality of bifurcated melt passages are located on a straight line on the inlet side, which is preferably the upper side of the melt distributor. As an alternative or in addition, all outlets of the bifurcated melt passages are located on the outlet side, which is preferably the lower side of the melt distributor. The line with the inlets and the line with the outlets may further preferably extend at right angles to one another, so that the pipeline parts of each bifurcated melt passage follow a space curve between the inlet and the outlets. This configuration contributes to the two discharging passage parts having a matching shape and length, especially a shape symmetrical to the central plane, so that the split melt flow enters in a multilayer extrusion head arranged downstream under matching conditions.

If the multilayer extrusion head extrudes the split melt flows by means of sleeves nested in one another with superimposed cardioid curve channels, the inlets and the branched junctions preferably extend each on a line, which extends parallel to the mold separating line of the blow molding machine.

The configuration according to the present disclosure of the complex structure of the bifurcated melt passages nested in one another, especially in the area of the branched junction, rules out the manufacture known from the state of the art due to holes in contiguous plates as well as millings in a separating plane between the plates.

The at least one bifurcated melt passage may be configured in a preferred embodiment of the present disclosure as a one-piece melt distributor consisting of bulk material. In this case, the melt distributor is manufactured as a one-piece component with a mold-less, additive manufacturing process for metallic materials. The one-piece component may have one, two or more melt passages, which are preferably arranged in ring segments radially adjacent to one another.

In another preferred embodiment, two or more ring segments may be configured as separate and preferably one-piece in itself components, wherein a bifurcated melt passage is configured in at least one ring segment with the branched junction and with the continuous curvature course. Due to the division of the melt distributor into ring segments, a modular configuration can be achieved, which makes possible a targeted adaptation to only one part of the melt flows or to one part of the melt flows, without having to remanufacture the entire melt distributor. A ring segment may on its own be changed, e.g., in order to provide a different flow geometry only for a certain melt flow, while the other ring segment or the other ring segments are maintained.

The one-piece configuration of the component melt distributor overall or ring segment, in which the bifurcated melt passage is accommodated, represents an independent aspect of the present disclosure. This especially applies to a multilayer melt distributor. One special advantage of the one-piece configuration is that the separate plane between the contiguous plates that is provided in the state of the art is dispensed with and leakage losses and edge adhesion zones are avoided as a result. Consequently, impurities of the melt due to resides from leakage gaps as well as operating disturbances and cleaning operations resulting therefrom are avoided. The outer contour of the melt passage may overall be formed by the one-piece component or by the one-piece ring segment so that the melt flow within the melt distributor does not encounter any partition lines extending obliquely to the flow direction or in tangential direction to the flow direction.

A one-piece configuration of the melt distributor with a complex channel geometry is successful due to the use of an additive manufacturing process for metallic materials in a departure from the prior-art machining manufacturing process with use of at least two plates. Such a manufacturing process is suitable for the formation of a one-piece component and allows the presetting of any desired inner space geometries with and without undercuts. In addition to the markedly reduced manufacturing costs for the melt distributor, the great freedom of geometry, which is especially important for the formation of the bifurcated melt passages, is mentioned as another advantage.

Selective laser melting (Selective Laser Melting in English, abbreviated as SLM) belongs to the additive manufacturing processes. It is readily suitable for metallic materials and is proposed for the manufacture of the melt distributor according to the present disclosure or a ring segment. As an alternative, any desired other manufacturing process, especially another additive manufacturing process may be used.

In selective laser melting, the metallic material to be processed is applied in powder form in a thin layer to a base plate. The material in powder form is locally entirely remelted by means of laser radiation and forms a solid layer of material after the solidification. The base plate is subsequently lowered by the amount of a layer thickness and powder is applied again. This cycle is repeated until all layers are remelted. The finished component is cleaned by the excess powder, separated from the base plate and then subjected to further processing or immediately used as needed. The typical layer thicknesses for the configuration of the component range between 15 μm to 500 μm regardless of the material. The data for the guiding of the laser beam are generated by means of a software from a 3D-CAD body. The component is divided into individual layers in the first calculation step. The paths (vectors), from which the laser beam departs, are generated for each layer in the second calculation step.

An extrusion head and especially a multilayer extrusion head for manufacturing thermoplastic, tubular preforms, which is equipped with a melt distributor according to the present invention, forms an assembly unit. A plurality of such assembly units may be advantageously structurally combined to form a multiple extrusion head for the simultaneous manufacture of a plurality of multilayer preforms.

The present invention is shown in examples and schematically in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a melt distributor according to the in-house state of the art;

FIG. 2A is a partially transparent view of a melt distributor according to the present disclosure in a front view and a side view from the left-hand side;

FIG. 2B is a partially transparent perspective view of the melt distributor according to FIG. 2A; and

FIG. 3 is a multiple extrusion head, which is connected to a plurality of extruders for providing different melt flows.

### DESCRIPTION OF PREFERRED EMBODIMENTS

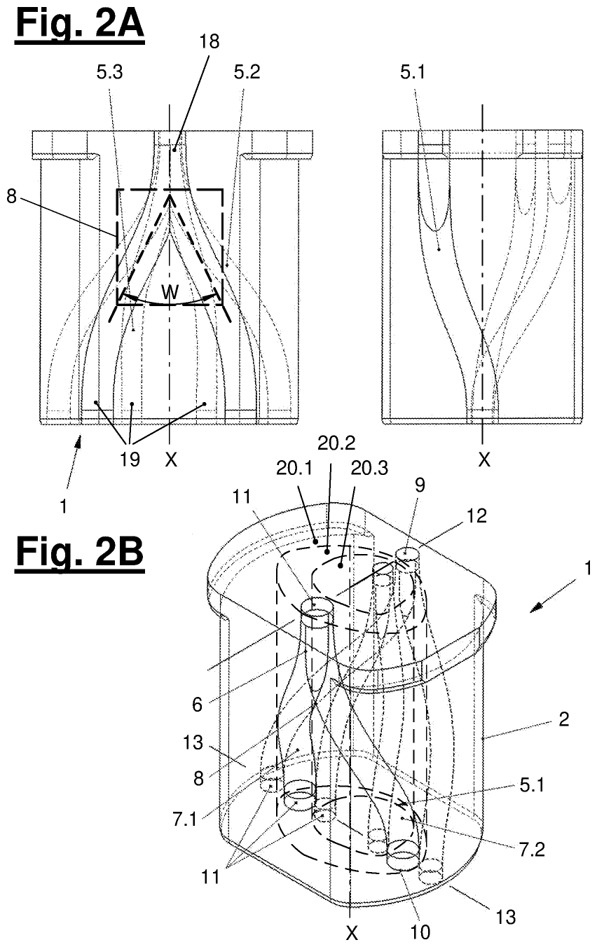

Referring to the drawings, A preferred embodiment of the melt distributor 1 according to the present disclosure is shown in related views in FIGS. 2A and 2B.

The melt distributor 1 comprises in the example a one-piece, metallic component 2 with an inlet side 3 and with an outlet side 4. The inlet side 3 is the upper side in the example and the outlet side 4 is the opposing lower side. This constellation is assumed below for simplification of the view. As an alternative, the inlet side 3 and the outlet side 4 may have a different orientation in relation to one another or in space.

Three bifurcated melt passages 5.1, 5.2, 5.3 extend between the inlet side 3 and the outlet side 4 in the example shown. The number of the melt passages may deviate from this example. One, two, three, four or even more melt passages may be provided. These melt passages may preferably be located in space zones adjacent to one another, so that the melt passages do not touch each other. One or more space zones may have a segment shape, which extends especially along a principal axis X as a linear body. A space zone may thus especially preferably have the shape of a cylinder ring. The principal axis X may be located in an axial center of the melt distributor. Another and preferably linear passage (not shown) may be provided there, which may be used, for example, for the passing through of a media connection or of a mechanical component.

In the simplest case, the melt distributor 1 comprises precisely one bifurcated melt passage with the branched junction 8 according to the present disclosure with the continuous curvature. In addition, other melt passages with different courses may be provided. As an alternative, two, three or all melt passages may, in turn, have a bifurcated course and a branched junction 8 according to the present disclosure.

The component 2 is configured, for example, as a one-piece, metallic block, in which the one or more bifurcated melt passages 5.1, 5.2, 5.3 are arranged as fluid-conveying passages. The block with the fluid-conveying passages forming the melt passages 5.1, 5.2, 5.3 is manufactured by way of an additive manufacturing process, especially by way of selective laser melting (Selective Laser Melting, abbreviated as SLM).

At least one and preferably each bifurcated melt passage 5.1, 5.2, 5.3 has a feeding passage part 6 for the melt as well as at least two discharging passage parts 7.1, 7.2 and precisely two discharging passage parts 7.1, 7.2 according to the preferred embodiment. The bifurcated melt passage 5.1, 5.2, 5.3 according to the present disclosure has a branched junction 8, which is highlighted by a box in FIG. 2A, between the feeding passage part 6 and the two discharging passage parts 7.1, 7.2. The branched junction 8 is configured as a rounded y-shaped line branch. The line branch may further preferably be configured as symmetrical, especially symmetrical to a central plane.

The feeding passage part 6 has an inlet 9 at the end. The inlets of a plurality of bifurcated melt passages may according to a preferred embodiment be located on the inlet side 3 of the component 2. Each discharging pipeline part 7.1, 7.2 has an outlet 10 at the end. All outlets 10 are preferably arranged on the outlet side 4. Adjoining the inlet 9 or the outlet 10, the individual passage parts or each passage part 6, 7.1, 7.2 may have a upstreeam section 18 or a downstream section 19 with a different geometry. A upstream section 18 or a downstream section 19 may have, in particular, a short, linear, cylindrical passage section 11. This may extend, for example, at right angles to the inlet side 3 or to the outlet side 4 of the component 2.

The branched junction between the feeding passage part 6 and the discharging passage parts 7.1, 7.2 of the bifurcated melt passage 5.1, 5.2, 5.3 and possibly the downstream sections of the discharging passage parts 7.1, 7.2, which sections adjoin the branched junction 8, follow, however, a bent curve, the curvature of which is continuous and is not equal to zero. This continuously bent course according to the present disclosure of the bifurcated melt passage has no deflections and no dead zones. A continuous curvature may also be called a steady curvature or as a course with a steadily changing value of the curvature.

The arc lengths of the bent curves in the branched junction 8 have according to an especially preferred embodiment a center angle W of less than 90°. This configuration may be intended for one, a plurality of or all bifurcated melt passages of the melt distributor 1.

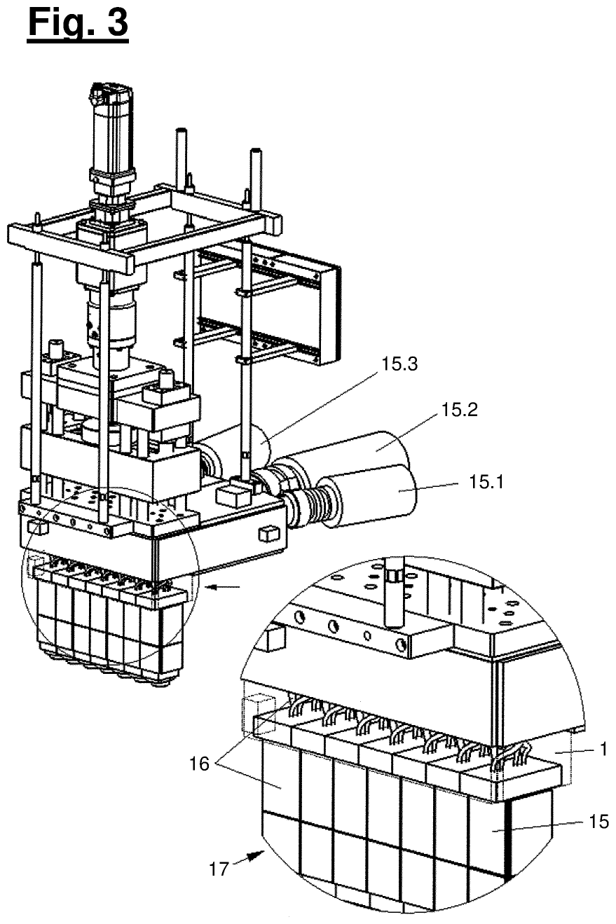

FIG. 3 shows an example for the interaction of the melt distributor 1 according to the present disclosure with one or more extruders and with an extrusion head. The inlets 9 of the melt distributor shown in FIGS. 2A and 2B can be connected or are connected in the example shown (directly) to the outlets of three extruders 14.1, 14.2, 14.3, shown only in FIG. 3. One extruder is a melt conveyor, which provides and conveys the melt flow from a thermoplastic plastic. In alternative embodiments, only one, two, four or any desired other number of extruders may be provided. Further, at least one melt flow may be provided from a different source.

The inlet 9 of the bifurcated melt passage 5.1 is connected to the extruder 14.1 for the formation of the principal layer of a preform from thermoplastic plastic. This bifurcated melt passage 5.1 has the largest inlet diameter. Thermoplastic plastic materials are fed via the two other bifurcated melt passages 5.2, 5.3 for the formation of other layers of the multilayer preform, which layers are combined in a tube-forming unit of a multilayer extrusion head 15.

The diameter located downstream, i.e., the outlet diameter at the outlets 10 and/or the passage diameter of the discharging passage parts 7.1, 7.2, are preferably smaller than the diameter located upstream, i.e., the inlet diameter of the feeding passage part 6. The ratio of the diameter located downstream to the diameters located upstream is preferably selected to be such that the flow velocity of the entering plastic melt is essentially equal to the flow velocity of the plastic melt being released. Furthermore, the sum of the passage diameters located downstream is preferably essentially equal to the passage diameters located upstream along the melt flow. As a result, the formation of dwell zones in the run of the melt flow is prevented. Dwell zones are often formed in passage areas, in which a local increase in the (cross-sectional) diameter occurs, which leads to a local reduction in the flow velocity. This reduced flow velocity may lead to the formation of deposits in the edge area of the passage, which may generate the same adverse effect, such as the dead zones mentioned above.

A bifurcated melt passage (5.1, 5.2, 5.3) has especially preferably a uniform overall passage diameter along the melt flow, so that the flow velocity (average in relation to the cross section) of the melt is essentially identical along the passage, especially preferably regardless of whether the melt is located in the feeding passage part (6) or (as a split melt flow) in the discharging passage parts (7.1, 7.2). In other words, the overall diameter of the passage parts is thus selected to be such that a uniform flow velocity is present within the bifurcated melt passage (5.1, 5.2, 5.3).

The overall passage diameter is identical to the local diameter of the feeding passage part (6) in a length section of the feeding passage part (6). In a length section of the (related and adjacent to one another) discharging passage parts (7.1, 7.2), the overall diameter is formed by the sum of the individual diameters of these discharging passage parts (7.1, 7.2), which are present at the length sections, which correspond to one another in the flow direction.

According to another aspect of the present disclosure, the curvature is preferably selected in each length area of the bifurcated melt passage (5.1, 5.2, 5.3) to be such that the ratio of the local radius of curvature to the local diameter of the passage is greater than or equal to a minimum ratio limit value. The minimum ratio limit value may be set as a function of the material of the plastic melt to be processed and of the pressure. It is especially at least 2.5. The minimum ratio limit value has especially preferably the value 3.

The above views assume that the passage parts (6, 7.1, 7.2) have an essentially circular or oval cross section, so that the diameter correlates directly with the cross-sectional area of the passage. Such a view is common in rheology and the essentially circular or oval cross-sectional shape is the preferred configuration. A person skilled in the art recognizes that a different geometric variable is also covered by the term “diameter,” which variable is suitable for describing the width of the respective passage and has a corresponding action for the conduction of the melt flow, taking the fluid-dynamic laws into consideration, especially with respect to the influence of the local flow velocity and with respect to the formation of dead zones and dwell zones.

All inlets 9 of the three bifurcated melt passages 5.1, 5.2, 5.3 extend in the example from FIG. 3 on a straight line 12 on the inlet side 3 of the melt distributor. And all outlets 10 of the bifurcated melt passages 5.1, 5.2, 5.3 extend on a straight line 13 on the outlet side 4 of the melt distributor 1. The lines 12, 13 extend in this case in the viewing direction of the principal axis X at right angles to one another, so that the passage parts 6, 7.1, 7.2 follow a branching, bent space curve between the inlet 9 and the two outlets 10. The two discharging passage parts 7.1, 7.2 have a matching shape, so that the melt flow distributed in the bifurcated melt passage 5.1, 5.2, 5.3 enters in the multilayer extrusion head 15 adjoining the melt distributor 1 under corresponding conditions. This matching symmetrical shape and length of the discharging passage parts may preferably be provided in a plurality of or in all melt passages.

A melt distributor 1 and a multilayer extrusion head 15 may each form an assembly unit 16.

As shown in FIG. 3, a plurality of assembly units 16 are preferably combined to form a multiple extrusion head 17 in order to extrude a plurality of preforms simultaneously, which preforms are each preferably built up from a plurality of melt layers.

It is, furthermore, possible to provide two, three or more adjacent groups of melt passages with the configuration according to the present disclosure in a melt distributor, wherein an extrusion head is arranged downstream of each group of melt passages.

Different variations of the present invention are possible. Especially the features shown, described or claimed in relation to the respective exemplary embodiments may be combined with each other in any desired manner or be replaced with each other.

A melt passage is according to the present disclosure a line passage for deflecting and possibly for distributing a melt from a thermoplastic plastic. The melt passage may be configured as a pipeline. A passage part may be correspondingly configured as a pipeline part.

While specific embodiments of the invention have been shown and described in detail to illustrate the application of the principles of the invention, it will be understood that the invention may be embodied otherwise without departing from such principles.

### LIST OF REFERENCE NUMBERS

Present invention (FIGS. 2 and 3)

1 Melt distributor

### 2 Component

3 Upper side/inlet side
4 Lower side/outlet side
5.1 Bifurcated melt passage/bifurcated pipeline
5.2 Bifurcated melt passage/bifurcated pipeline
5.3 Bifurcated melt passage/bifurcated pipeline
6 Feeding passage part/feeding pipeline part
7.1 Discharging passage part/discharging pipeline part
7.2 Discharging passage part/discharging pipeline part
8 Branched junction

### 9 Inlet

### 10 Outlet

11 Cylindrical passage section
12 Straight line
13 Straight line
14.1 Extruder/melt conveyor
14.2 Extruder/melt conveyor
14.3 Extruder/melt conveyor
15 Multilayer extrusion head
16 Assembly unit
17 Multiple extrusion head
18 Upstream section
19 Downstream section
20.1 Ring segment
20.2 Ring segment
20.3 Ring segment
W Center angle

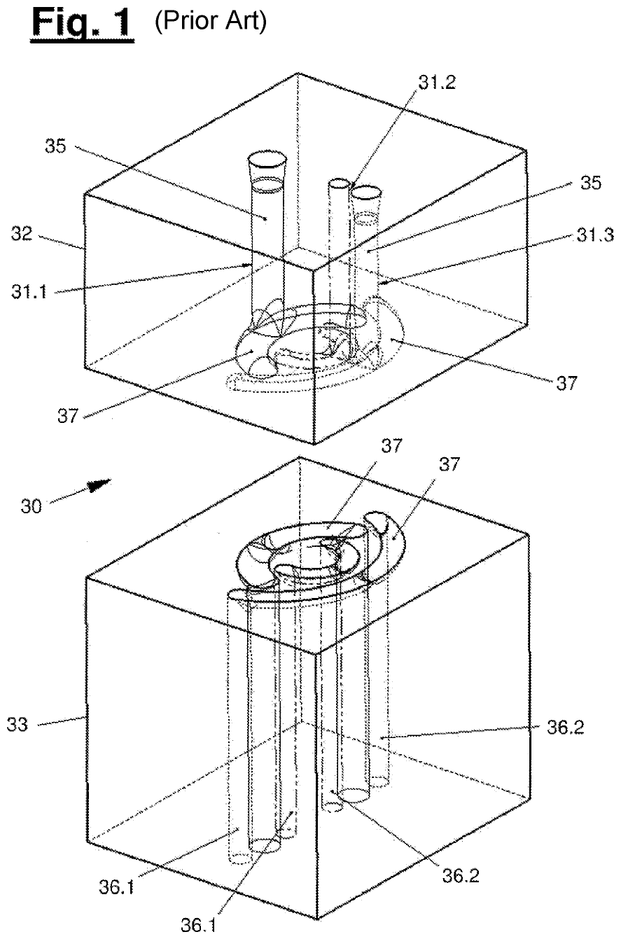

State of the Art (FIG. 1)

30 Melt distributor
31.1 Bifurcated pipeline
31.2 Bifurcated pipeline
31.3 Bifurcated pipeline
32 Upper plate
33 Lower plate
34 Separating plane
35 Feeding pipeline part
36.1 Discharging pipeline part
36.2 Discharging pipeline part

### 37 Junction

1. A melt distributor for deflecting and distributing melt from a thermoplastic plastic, wherein the melt distributor can be connected to a multilayer extrusion head for the manufacture of multilayer preforms from the melt of the plurality of melt flows, the melt distributor comprising:
one or more bifurcated melt passages, each of the one or more bifurcated melt passages comprising:
a feeding passage part
at least two discharging passage parts; and
a branched junction provided between the feeding passage part and the at least two discharging passage parts,
wherein the feeding passage part has an inlet for the melt at an end thereof, and each of the at least two discharging passage parts has an outlet for the melt at an end thereof,
wherein at least the branched junction is configured as a rounded Y-shaped line branch, and wherein the branched junction is arranged between the feeding passage part and the two connected discharging passage parts follows a continuously bent curve, a curvature of which is not equal to zero; and
wherein the melt distributor comprises a one-piece component and each of the one or more bifurcated melt passages are arranged in the one-piece component, and wherein the one piece component provided with the one or more bifurcated melt passages is manufactured with a mold-less, additive manufacturing process for metallic material.

2. A melt distributor for deflecting and distributing a melt of a thermoplastic plastic, wherein the melt distributor is connected to a multilayer extrusion head for the manufacture of multilayer preforms from the melt of the plurality of melt flows, the melt distributor comprising:
a plurality of bifurcated melt passages, each of the plurality of bifurcated melt passage comprising:
a feeding passage part;
at least two discharge passage parts; and
a branched junction between the feeding passage part and the discharging passage parts,
wherein the feeding passage part has an inlet for the melt at an end thereof and each discharging passage part has an outlet for the melt at an end thereof,
wherein at least the branched junction is a rounded Y-shaped line junction and wherein the branched junction between the feeding passage part and the two connected discharge passage parts follows a continuously bent curve, which is not equal to zero,
wherein the melt distributor is configured with two or more ring segments which are arranged radially adjacent to each other,
wherein each of the plurality bifurcated melt passages is arranged in one of the ring segments and the melt distributor is configured as a one-piece component; or a subset of the plurality of bifurcated melt passages is arranged in one of the ring segments and the melt distributor is configured as a one-piece component, and
wherein in the one-piece component with the bifurcated melt passage or with the bifurcated melt passages is manufactured with a mold-less, additive manufacturing process for metallic materials.

3. A melt distributor according to claim 1, wherein arc lengths of the bent curves in the branched junction have a center angle of less than 90°.

4. A melt distributor according to claim 1, wherein at the branched junction of a bifurcated melt passage a upstream section of the feeding passage part and/or wherein each branched junction is followed by a downstream section of the discharge passage parts, and wherein the upstream section or the downstream sections also follow a continuously bent curve, the curvature of which is not equal to zero.

5. A melt distributor according to claim 1, wherein a plurality of inlets of the plurality of bifurcated melt passages are located on a straight line at an inlet side of the melt distributor and/or wherein a plurality of outlets or all of the outlets of the bifurcated melt passages are located on a straight line at the outlet side of the melt distributor.

6. A melt distributor according to claim 1, wherein all inlets are arranged on an inlet side of the melt distributor are and/or all outlets are arranged on an opposite outlet side of the melt distributor.

7. A melt distributor according to claim 1, wherein the one or more bifurcated melt passages has downstream located diameters, comprising an end diameter or exit diameter of the discharging passage parts and/or of the outlet, and has an upstream located diameter, comprising an inlet diameter of the feeding passage part and/or the inlet, wherein a ratio of the downstream located diameter to the upstream located diameters is selected such that a flow velocity of the incoming plastic melt is essentially equal to a flow velocity of the plastic melt being released; and/or wherein along the melt flow, the sum of the passage diameters located downstream is essentially equal to the passage diameters located upstream.

8. A melt distributor according to claim 1, wherein the one or more bifurcated melt passages along a melt flow direction have a uniform overall passage diameter, so that within the one or more bifurcated melt passages a uniform flow velocity exists.

9. A melt distributor in accordance with claim 1, wherein the curvature in each length area of the one or more bifurcated melt passages is selected such that a ratio of the local radius of curvature to a local diameter of the one or more bifurcated melt passages is greater than or equal to a minimum ratio limit value, wherein the minimum ratio value is greater than.

10. An assembly unit comprising an extrusion head, and a melt distributor according to claim 1.

11. A mulitple extrusion head for a simultaneous manufacture of a plurality of multilayer preforms, the multiple extrusion head comprising a plurality of assembly units in accordance with claim 10, in which a plurality of adjacent groups of bifurcated melt passages are provided.

12. A melt distributor according to claim 2, wherein arc lengths of the bent curves in the branched junction have a center angle of less than 90°.

13. A melt distributor according to claim 2, wherein at the branched junction of a bifurcated melt passage a upstream section of the feeding passage part and/or wherein each branched junction is followed by a downstream section of the discharge passage parts, and wherein the upstream section or the downstream sections also follow a continuously bent curve, the curvature of which is not equal to zero.

14. A melt distributor according to claim 2, wherein a plurality of inlets of the plurality of bifurcated melt passages are located on a straight line at an inlet side of the melt distributor and/or wherein a plurality of outlets or all of the outlets of the bifurcated melt passages are located on a straight line at the outlet side of the melt distributor.

15. A melt distributor according to claim 2, wherein all inlets are arranged on an inlet side of the melt distributor are and/or all outlets are arranged on an opposite outlet side of the melt distributor.

16. A melt distributor according to claim 2, wherein the one or more bifurcated melt passages has downstream located diameters, comprising an end diameter or exit diameter of the discharging passage parts and/or of the outlet, and has an upstream located diameter, comprising an inlet diameter of the feeding passage part and/or the inlet, wherein a ratio of the downstream located diameter to the upstream located diameters is selected such that a flow velocity of the incoming plastic melt is essentially equal to a flow velocity of the plastic melt being released; and/or wherein along the melt flow, the sum of the passage diameters located downstream is essentially equal to the passage diameters located upstream.

17. A melt distributor according to claim 2, wherein the one or more bifurcated melt passages along a melt flow direction have a uniform overall passage diameter, so that within the one or more bifurcated melt passages a uniform flow velocity exists.

18. A melt distributor in accordance with claim 2, wherein the curvature in each length area of the one or more bifurcated melt passages is selected such that a ratio of the local radius of curvature to a local diameter of the one or more bifurcated melt passages is greater than or equal to a minimum ratio limit value, wherein the minimum ratio value is greater than.
